(19) United States
(12) Patent Application Publication
(10) Pub. No.: US 2003/0060231 A1
(43) Pub. Date: Mar. 27, 2003

(54) Method for operating a communications system

(76) Inventors: Bruno Bozionek, Borchen (DE); Rainer Zimmermann, Paderborn (DE)

Correspondence Address: STAAS & HALSEY LLP, 700 11TH STREET, NW, SUITE 500, WASHINGTON, DC, 20001, US

(21) Appl. No.: 10/130,473

(22) PCT Filed: Aug. 31, 2001
(86) PCT No.: PCT/DE01/03344

(30) Foreign Application Priority Data
Sep. 19, 2000 (DE) 10046339.8

(51) Int. Cl. H04Q 7/20

(52) U.S. Cl. 455/556; 455/422; 455/466

(57) ABSTRACT

The invention relates to a method for operating a communications system comprising at least one communications installation and at least one terminal which is connected to the communications installation. Following a user-input request for text and/or graphics information that is formatted according to a protocol for wireless transmission of text and/or graphics information (TGI), the terminal (TE1, TE2, TE3) determines address information (AI) using a selection input (SI) describing the requested text and/or graphics information (TGI) and transmits said address information to a control unit (CTL) that is allocated to the communications installation (PBX). Said control unit (CTL) establishes a connection for a packet-oriented data transmission to a server (WAP-SRV) that is described by the address information (AI) and sends a request (RQ) to transmit the text and/or graphics information (TGI) that is described by the selection input (SI) to the server (WAP-SRV). Text and/or graphics information (TGI) that is received by the server (WAP-SRV) through the communications installation (PBX) is transmitted to the terminal (TE1, TE2, TE3) for which the text/graphics information (TGI) was requested.

### CROSS REFERENCE TO RELATED APPLICATIONS

This application is based on and hereby claims priority to PCT Application No. PCT/DE01/03344 filed on Aug. 31, 2001 and German Application No. 100 46 339.8 filed on Sep. 19, 2000, the contents of which are hereby incorporated by reference.

### BACKGROUND OF THE INVENTION

In previously known communications terminals connected to a communications installation, only text and graphics information which is prescribed and generated by the respective communications installation can be displayed. Control elements and display devices on the communications terminals therefore cannot be used to retrieve and display any text and graphics information which is desired. These restrictions prevent standardization of the available services in communications systems having a plurality of different communications installations. One possible consequence of this is inconsistencies in the services available in a communications system.

### SUMMARY OF THE INVENTION

Aspects of the present invention are based on the object of specifying a method for operating a communications system in order to standardize services available in a communications system. a method having the features specified in claim 1. Advantageous refinements of the inventive method can be found in the dependent claims 2 to 7.]

One fundamental aspect of the method can be seen in that communications terminals have text and graphics information made available on them whose content is not necessarily known to a communications installation to which the respective terminal is connected. This is because text and graphics information requested for a terminal is formatted on a system-standard basis in line with a protocol for wireless transmission of text and graphics information, for example the known Wireless Access Protocol (WAP).

The low complexity of the protocol means that such formatted text and graphics information can be converted to virtually any device-specific data format which can be displayed by the respective terminal. This means that services which are activated or deactivated by an exchange of text and graphics information, for example, can also be extensively standardized within a communications system for terminals connected to the respective communications installations.

In accordance with one advantageous refinement of the method, telephone book entries form elements of text and graphics information. The telephone book entries have at least details relating to the name and telephone number of a subscriber. This provides a service which is standard for all systems.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a communications system having a communications installation and a plurality of terminals,

FIG. 2 shows another communications system having an additional separate program control device, and

FIG. 3 shows a flowchart for a method for operating a communications system.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

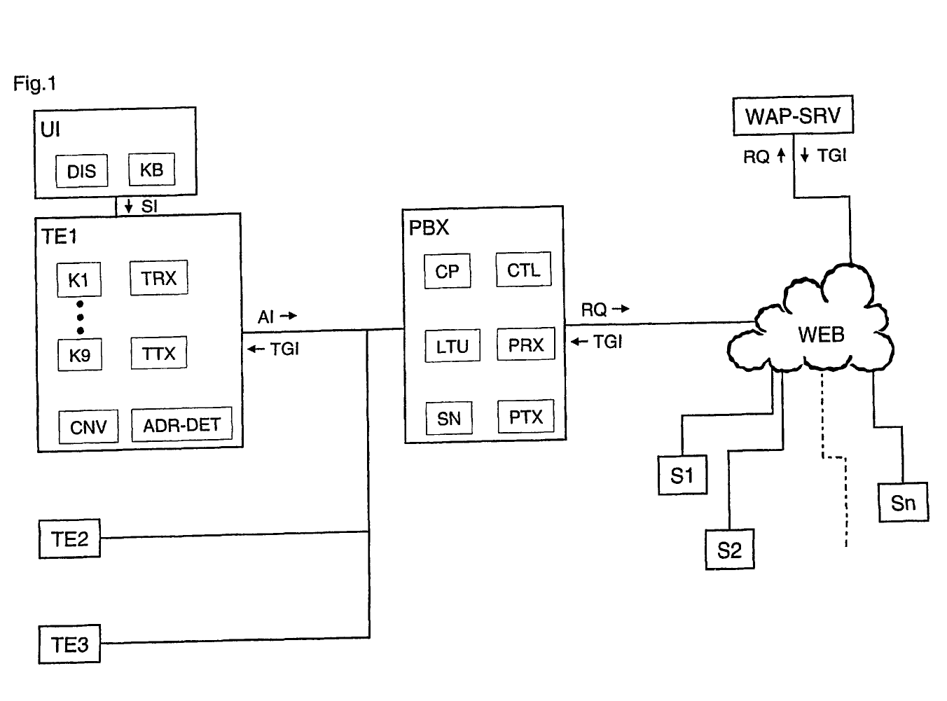

The communications system shown in FIG. 1 has a communications installation PBX and a plurality of terminals TE1, TE2, TE3 connected to the communications installation PBX. The communications installation PBX is equipped with a switching network SN, a call-processing control unit CP and a peripheral access facility LTU.

In the event of a user-input request for text and graphics information TGI formatted in line with a protocol for wireless transmission of text and graphics information, a selection input SI is used to ascertain address information AI in an address-value detection device ADR-DET in a terminal TE1. The selection input SI designates the requested text and graphics information TGI. A transmission device TTX in the terminal TE1 transmits the address information AI to a reception device PRX in the communications installation PBX. The protocol used for wireless transmission of text and graphics information is the Wireless Access Protocol (WAP).

A control device CTL in the communications installation PBX sets up a connection for packet-oriented data transmission to a server WAP-SRV designated by the address information AI. In addition, the control device CTL sends a request RQ to the server WAP-SRV for transmission of the text and graphics information TGI designated by the selection input SI. Preferably, the communications installation PBX has an interface (not shown in more detail) to a network WEB for packet-oriented data transmission. An example of such a network WEB is the Internet or an intranet within a company. Text and graphics information requested for a terminal TE1, TE2, TE3 can thus be retrieved from a multiplicity of servers S1 to Sn.

The server WAP-SRV sends the text and graphics information TGI to the communications installation PBX via the network WEB in line with the request RQ. A transmission device PTX in the communications installation PBX is used to transmit the text and graphics information TGI received from the server WAP-SRV to a reception device TRX in the terminal TE1 for which the text and graphics information TGI was requested. A conversion device CNV in the terminal TE1 converts the text and graphics information TGI to a data format which can be displayed by the terminal TE1.

A user interface device UI for the terminal TE1 is used to visualize selection information designating retrievable text and graphics information TGI. The user interface device UI has an associated display device DIS and an associated keyboard KB. Selection information visualized on the terminal TE1 can thus be made available for the user-input request. The request input by the user can alternatively be made by pressing a selection key K1 to K9 preprogrammed on the terminal TE1.

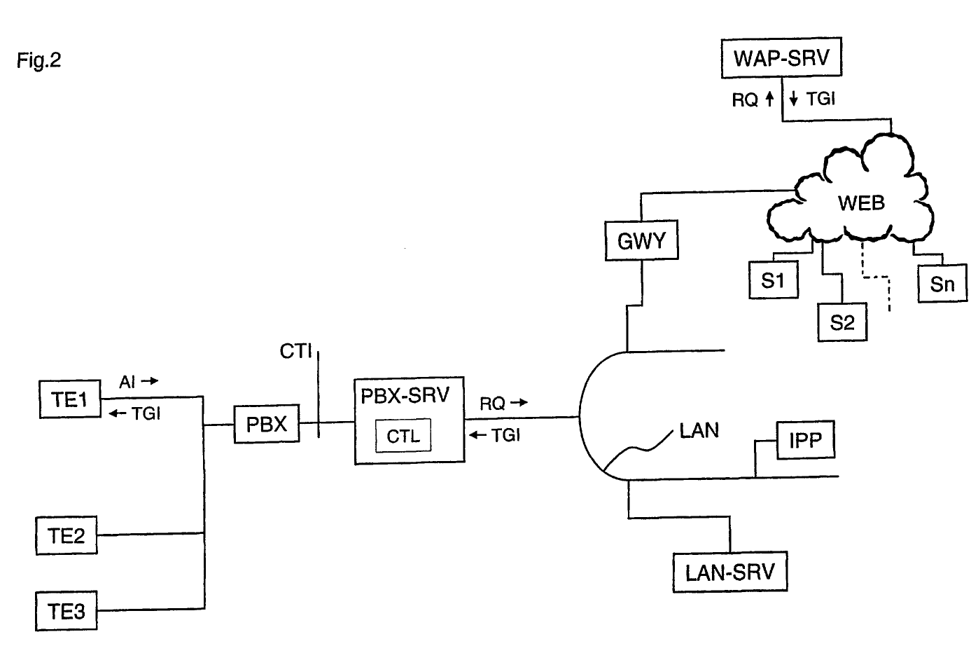

The communications system shown in FIG. 2 additionally has a separate program control device PBX-SRV associated with the communications installation PBX. The program control device PBX-SRV is coupled to the communications installation PBX via a CTI interface CTI (Computer Telephone Integration), for example. Data are interchanged between the communications installation PBX and the program control device PBX-SRV in line with the CSTA phase III protocol. The reception unit PRX, the transmission unit PTX, the control unit CTL, the converter device CNV and the address-value detection device ADR-DET are thus not associated with the communications installation PBX but rather with the program control device

The program control device PBX-SRV has an interface (not shown in more detail) to a local area network LAN. Connected to the local area network are both an IP telephone IPP (Internet Protocol) for packet-oriented voice information transmission and also another server LAN-SRV, on which text and graphics information formatted in line with the Wireless Access Protocol (WAP) can be retrieved. In the case of the communications system shown in FIG. 2, the local area network LAN is coupled to the network WEB via a gateway GWY. A connection is thus available for packet-oriented data transmission between the program control device PBX-SRV and the server WAP-SRV. The program control device PBX-SRV can thus perform tasks associated with a proxy server operating as a virtual service requester on behalf of the terminals TE1, TE2, TE3 connected to the communications installation PBX.

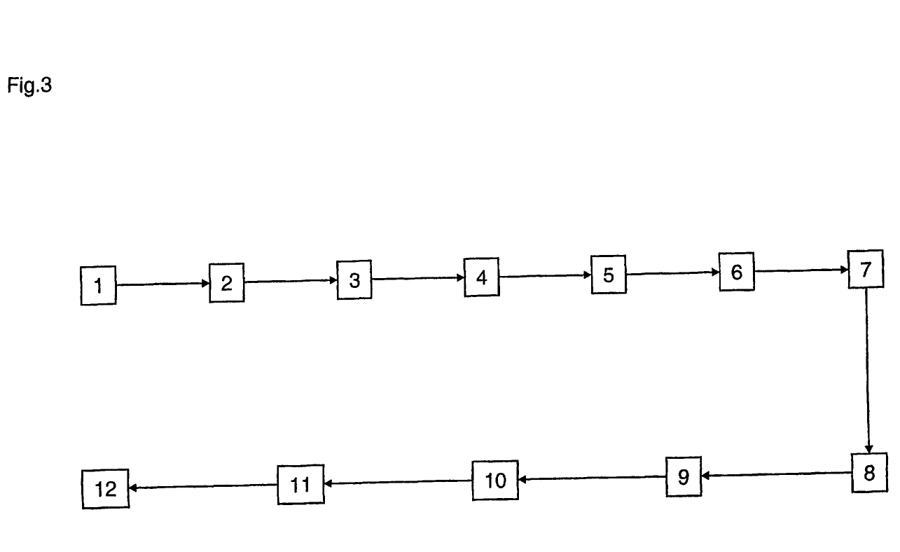

In the flowchart shown in FIG. 3, functions on a terminal TE1, TE2, TE3 are first activated (step 1) in order to request text and graphics information TGI formatted in line with the Wireless Access Protocol (WAP). Next, the communications installation PBX or the program control device PBX-SRV transmits selection information for the user-input request to the respective terminal TE1, TE2, TE3 (step 2). On the basis of the selection information visualized on the terminal TE1, TE2, TE3, wanted text and graphics information TGI is selected (step 3). The address-value detection device ADR-DET then uses a selection input SI designating the selected text and graphics information TGI to ascertain address information AI (step 4). The address information AI ascertained is then transmitted to the communications installation PBX and the program control device PBX-SRV (step 5).

The communications installation PBX or the program control device PBX-SRV then sets up a connection to the server WAP-SRV designated by the address information AI (step 6) and transmits to said server a request RQ for transmission of the selected text and graphics information TGI (step 7). When the request RQ has been analyzed by the server WAP-SRV (step 8), the requested text and graphics information TGI is transmitted to the communications installation PBX and the program control device PBX-SRV (step A9). The text and graphics information TGI received from the server WAP-SRV is transmitted by the transmission device PTX in the communications installation PBX to the terminal TE1 for which the text and graphics information TGI was requested (step 10). The text and graphics information TGI is then converted in the converter device CNV to the data format which can be displayed by the terminal TE1 (step 11) and is displayed on the display device DIS for the terminal TE1 (step 12).

In one advantageous refinement of the method, for example, telephone book entries having at least details relating to the names and telephone numbers of subscribers as elements of text and graphics information make a system-standard service available within a communications system. Another service based on the method is the sending and receiving of short messages (SMS—Short Message Services) to terminals connected to a communications installation. A prerequisite for this is that the respective communications installation provides an opportunity to access mobile radio networks.

The invention has been described in detail with particular reference to preferred embodiments thereof and examples, but it will be understood that variations and modifications can be effected within the spirit and scope of the invention.

In previously known communications terminals connected to a communications installation, only text and graphics information which is prescribed and generated by the respective communications installation can be displayed. Control elements and display devices on the communications terminals therefore cannot be used to retrieve and display any text and graphics information which is desired. These restrictions prevent standardization of the available services in communications systems having a plurality of different communications installations. One possible consequence of this is inconsistencies in the services available in a communications system.

The present invention is based on the object of specifying a method for operating a communications system in order to standardize services available in a communications system.

The invention achieves this object by means of a method having the features specified in claim 1. Advantageous refinements of the inventive method can be found in the dependent claims 2 to 7.

One fundamental aspect of the inventive method can be seen in that communications terminals have text and graphics information made available on them whose content is not necessarily known to a communications installation to which the respective terminal is connected. This is because text and graphics information requested for a terminal is formatted on a system-standard basis in line with a protocol for wireless transmission of text and graphics information, for example the known Wireless Access Protocol (WAP). The low complexity of the protocol means that such formatted text and graphics information can be converted to virtually any device-specific data format which can be displayed by the respective terminal. This means that services which are activated or deactivated by means of an exchange of text and graphics information, for example, can also be extensively standardized within a communications system for terminals connected to the respective communications installations.

In accordance with one advantageous refinement of the inventive method, telephone book entries form elements of text and graphics information. The telephone book entries have at least details relating to the name and telephone number of a subscriber. This provides a service which is standard for all systems.

The invention is explained in more detail below using exemplary embodiments with reference to the drawing, in which

FIG. 1 shows a communications system having a communications installation and a plurality of terminals,

FIG. 2 shows another communications system having an additional separate program control device, and

FIG. 3 shows a flowchart for a method for operating a communications system.

The communications system shown in FIG. 1 has a communications installation PBX and a plurality of terminals TE1, TE2, TE3 connected to the communications installation PBX. The communications installation PBX is equipped with a switching network SN, a call-processing control unit CP and a peripheral access facility LTU.

In the event of a user-input request for text and graphics information TGI formatted in line with a protocol for wireless transmission of text and graphics information, a selection input SI is used to ascertain address information AI in an address-value detection device ADR-DET in a terminal TE1. The selection input SI designates the requested text and graphics information TGI. A transmission device TTX in the terminal TE1 transmits the address information AI to a reception device PRX in the communications installation PBX. The protocol used for wireless transmission of text and graphics information is the Wireless Access Protocol (WAP).

A control device CTL in the communications installation PBX sets up a connection for packet-oriented data transmission to a server WAP-SRV designated by the address information AI. In addition, the control device CTL sends a request RQ to the server WAP-SRV for transmission of the text and graphics information TGI designated by the selection input SI. Preferably, the communications installation PBX has an interface (not shown in more detail) to a network WEB for packet-oriented data transmission. An example of such a network WEB is the Internet or an intranet within a company. Text and graphics information requested for a terminal TE1, TE2, TE3 can thus be retrieved from a multiplicity of servers S1 to Sn.

The server WAP-SRV sends the text and graphics information TGI to the communications installation PBX via the network WEB in line with the request RQ. A transmission device PTX in the communications installation PBX is used to transmit the text and graphics information TGI received from the server WAP-SRV to a reception device TRX in the terminal TE1 for which the text and graphics information TGI was requested. A conversion device CNV in the terminal TE1 converts the text and graphics information TGI to a data format which can be displayed by the terminal TE1.

A user interface device UI for the terminal TE1 is used to visualize selection information designating retrievable text and graphics information TGI. The user interface device UI has an associated display device DIS and an associated keyboard KB. Selection information visualized on the terminal TE1 can thus be made available for the user-input request. The request input by the user can alternatively be made by pressing a selection key K1 to K9 preprogrammed on the terminal TE1.

The communications system shown in FIG. 2 additionally has a separate program control device PBX-SRV associated with the communications installation PBX. The program control device PBX-SRV is coupled to the communications installation PBX via a CTI interface CTI (Computer Telephone Integration), for example. Data are interchanged between the communications installation PBX and the program control device PBX-SRV in line with the CSTA phase III protocol. The reception unit PRX, the transmission unit PTX, the control unit CTL, the converter device CNV and the address-value detection device ADR-DET are thus not associated with the communications installation PBX but rather with the program control device PBX-SRV.

The program control device PBX-SRV has an interface (not shown in more detail) to a local area network LAN. Connected to the local area network are both an IP telephone IPP (Internet Protocol) for packet-oriented voice information transmission and also another server LAN-SRV, on which text and graphics information formatted in line with the Wireless Access Protocol (WAP) can be retrieved. In the case of the communications system shown in FIG. 2, the local area network LAN is coupled to the network WEB via a gateway GWY. A connection is thus available for packet-oriented data transmission between the program control device PBX-SRV and the server WAP-SRV. The program control device PBX-SRV can thus perform tasks associated with a proxy server operating as a virtual service requester on behalf of the terminals TE1, TE2, TE3 connected to the communications installation PBX.

In the flowchart shown in FIG. 3, functions on a terminal TE1, TE2, TE3 are first activated (step 1) in order to request text and graphics information TGI formatted in line with the Wireless Access Protocol (WAP). Next, the communications installation PBX or the program control device PBX-SRV transmits selection information for the user-input request to the respective terminal TE1, TE2, TE3 (step 2). On the basis of the selection information visualized on the terminal TE1, TE2, TE3, wanted text and graphics information TGI is selected (step 3). The address-value detection device ADR-DET then uses a selection input SI designating the selected text and graphics information TGI to ascertain address information AI (step 4). The address information AI ascertained is then transmitted to the communications installation PBX and the program control device PBX-SRV (step 5).

The communications installation PBX or the program control device PBX-SRV then sets up a connection to the server WAP-SRV designated by the address information AI (step 6) and transmits to said server a request RQ for transmission of the selected text and graphics information TGI (step 7). When the request RQ has been analyzed by the server WAP-SRV (step 8), the requested text and graphics information TGI is transmitted to the communications installation PBX and the program control device PBX-SRV (step A9). The text and graphics information TGI received from the server WAP-SRV is transmitted by the transmission device PTX in the communications installation PBX to the terminal TE1 for which the text and graphics information TGI was requested (step 10). The text and graphics information TGI is then converted in the converter device CNV to the data format which can be displayed by the terminal TE1 (step 11) and is displayed on the display device DIS for the terminal TE1 (step 12).

In one advantageous refinement of the inventive method, for example, telephone book entries having at least details relating to the names and telephone numbers of subscribers as elements of text and graphics information make a system-standard service available within a communications system. Another service based on the inventive method is the sending and receiving of short messages (SMS—Short Message Services) to terminals connected to a communications installation. A prerequisite for this is that the respective communications installation provides an opportunity to access mobile radio networks.

The application of the invention is not limited just to the exemplary embodiments described herein.

1. A method for operating a communications system having at least one communications installation and at least one terminal connected to the communications installation, in which
in the event of a user-input request for text and/or graphics information (TGI) formatted in line with a protocol for wireless transmission of text and graphics information, the terminal (TE1, TE2, TE3) uses a selection input (SI) designating the requested text and/or graphics information (TGI) to ascertain address information (AI) and transmits it to a control unit (CTL) associated with the communications installation (PBX),
the control unit (CTL) sets up a connection for packet-oriented data transmission to a server (WAP-SRV) designated by the address information (AI) and sends a request (RQ) to the server (WAP-SRV) for transmission of the text and/or graphics information (TGI) designated by the selection input (SI),
text and/or graphics information (TGI) received from the server (WAP-SRV) by the communications installation (PBX) is transmitted to the terminal (TE1, TE2, TE3) for which the text and/or graphics information (TGI) was requested.

2. The method as claimed in claim 1,
characterized in that the text and/or graphics information (TGI) transmitted to the terminal (TE1, TE2, TE3) is converted to a data format which can be displayed by the terminal (TE1, TE2, TE3) for which the text and/or graphics information (TGI) was requested.

3. The method as claimed in claim 2,
characterized in that the text and/or graphics information (TGI) is converted in the terminal (TE1, TE2, TE3) to the data format which can be displayed by the terminal (TE1, TE2, TE3).

4. The method as claimed in one of claims 1 to 3,
characterized in that selection information designating retrievable text and/or graphics information (TGI) is visualized on a user interface device (UI) for the terminal (TE1, TE2, TE3).

5. The method as claimed in claim 4,
characterized in that selection information visualized on the terminal (TE1, TE2, TE3) is made available for the user-input request.

6. The method as claimed in one of claims 1 to 5,
characterized in that the user-input request is made by pressing a selection key (K1-K9) preprogrammed on the terminal.

7. The method as claimed in one of claims 1 to 6,
characterized in that telephone book entries which at least have details relating to the name and telephone number of a subscriber form elements of the text and/or graphics information (TGI).
